(19) United States
(12) Patent Application Publication
(10) Pub. No.: US 2024/0202385 A1
(43) Pub. Date: Jun. 20, 2024

(54) METHOD FOR DESIGNING VACUUM SYSTEM, METHOD FOR SELECTING OPTIMAL PUMP CAPACITY WHEN DESIGNING VACUUM SYSTEM, AND METHOD FOR DISPLAYING DESIGN SCREEN OF VACUUM SYSTEM AND APPARATUS THEREFOR

(71) Applicant: Tae Ook KANG, Asan-si (KR)

(72) Inventor: Tae Ook KANG, Asan-si (KR)

(21) Appl. No.: 18/284,220

(22) PCT Filed: Dec. 7, 2020
(86) PCT No.: PCT/KR2020/017741

§ 371 Date: Sep. 26, 2023

(30) Foreign Application Priority Data
Aug. 14, 2020 (KR) 10-2020-0102782
Dec. 3, 2020 (KR) 10-2020-0167313
Dec. 4, 2020 (KR) 10-2020-0168230

(51) Int. Cl. G06F 30/18; G06F 30/20; G06F 111/20; G06F 113/14

(52) U.S. Cl. CPC G06F 30/18; G06F 30/20; G06F 2111/20; G06F 2113/14

(57) ABSTRACT

A method for designing a vacuum system including a chamber, a pipe, and a pump according to one embodiment of the present disclosure for achieving the aforementioned problem, comprises the steps of: setting process conditions, according to a user input, of a first vacuum system disposed in a virtual region, the process conditions including the starting pressure of a chamber, the target pressure thereof, and the time to reach the target pressure thereof and including at least one of a process pressure at a maximum gas load or flow, a gas load at the maximum process pressure, and a gas load at a minimum process pressure, simulating operations of the first vacuum system on the basis of specifications of the chamber, the pipe, and the pump, and providing the set process conditions and results of the simulation.

### TECHNICAL FIELD

The present disclosure relates to a method and apparatus for designing a vacuum system, and more particularly, to a method and apparatus for designing an optimal vacuum system that satisfies the process conditions set by a user, selecting a highly efficient piping configuration and an optimal pump capacity when designing a vacuum system, and displaying a design screen of a vacuum system.

### BACKGROUND

Vacuum technology is a technology that makes a chamber (vessel) into a vacuum and enables various experiments or production therein. Vacuum technology does not create anything by itself but is a base technology that provides the basis for research and manufacturing. Here, vacuum refers to a state in which the gas pressure in the space is lower than atmospheric pressure.

On the other hand, a vacuum system consisting of a chamber, piping, and a pump turns the inside of the chamber into a vacuum state at a level required for manufacturing or research, enabling smooth process progress. Vacuum prevents reactions or oxidation caused by the influence of other gases, lowers the boiling point of substances, cleans the surface, removes residual gases, and facilitates the introduction of desired substances.

Vacuum systems that provide such effects have been applied to all industrial fields, and have been widely applied, in particular, to large-scale base industries such as semiconductors and displays.

However, the reality is that most vacuum systems used in the field have inefficient parts due to the use of large pumps with unnecessarily large capacities or low-efficiency piping configurations, such as the use of excessive bends, narrow pipes, and reducers.

Accordingly, there is a need for measures that make it possible to design an optimal vacuum system that can satisfy the process conditions set by a user, and select piping and a pump of optimal specifications that satisfy the process conditions set by the user through vacuum system simulation when designing the vacuum system.

Furthermore, there is a need to develop a user interface that provides a vacuum system and graphs before/after improvement on a split screen so as to make it easy to intuitively check, compare, and analyze an optimal vacuum system being designed.

### SUMMARY

### Technical Objects

It is an object of the present disclosure to provide measures that make it possible to design a vacuum system by visual modeling, to check whether piping and a pump satisfy the process conditions set by a user in the design of the vacuum system, and to improve inefficient piping sections.

It is another object of the present disclosure to provide measures that design a vacuum system by visual modeling, check through simulation whether a pump in the vacuum system satisfies the process conditions set by a user, and optimize the capacity of the pump when designing the vacuum system.

It is yet another object of the present disclosure to provide a system and method for displaying a design screen of a vacuum system that implements a user interface so as to enable intuitive comparison and analysis by designing a vacuum system by visual modeling, checking whether piping and a pump satisfy the process conditions set by a user in the design of the vacuum system, and including a plurality of vacuum systems including first and second vacuum systems, etc., and one or more graphs as the results of system simulations and providing them on a split screen.

### Technical Solution

A method for designing a vacuum system including a chamber, piping, and a pump in accordance with one embodiment of the present disclosure for achieving the objects described above comprises: (a) setting process conditions (including a start pressure of the chamber, a target pressure thereof, and a time to reach the target pressure) of a first vacuum system disposed in a virtual region according to a user input; (b) simulating the operation of the first vacuum system based on specifications of the chamber, the piping, and the pump; and (c) providing the set process conditions and results of the simulation.

In addition, an apparatus for designing a vacuum system including a chamber, piping, and a pump in accordance with one embodiment of the present disclosure comprises: one or more processors; and a memory configured to be connected with the processors, wherein the memory stores program instructions executable by the processors so as to set process conditions (including a start pressure of the chamber, a target pressure thereof, and a time to reach the target pressure) of a first vacuum system disposed in a virtual region according to a user input, simulate the operation of the first vacuum system based on specifications of the chamber, the piping, and the pump, and provide the set process conditions and results of the simulation.

Further, a method for selecting a pump of an optimal capacity in a vacuum system including a chamber, piping, and a pump in accordance with one embodiment of the present disclosure comprises: (a) setting specifications and process conditions of a chamber, piping, and a pump of a first vacuum system disposed in a virtual region according to a user input; (b) simulating the first vacuum system based on the specifications of the chamber, piping, and pump; (c) displaying a first simulation result showing a time to reach a target pressure from a chamber start pressure and a second simulation result showing a change in chamber vacuum according to a change in gas load (or flow), as results of the simulation; and (d) selecting a pump capacity (peak pumping speed) that satisfies all of the process conditions for each of the first simulation result and the second simulation result, wherein the process conditions comprise first process conditions related to the first simulation result and second process conditions related to the second simulation result.

Moreover, an apparatus for optimized design of a vacuum system including a chamber, piping, and a pump in accordance with one embodiment of the present disclosure comprises: one or more processors; and a memory configured to be connected with the processors, wherein the memory stores program instructions executable by the processors so as to set specifications and process conditions of a chamber, piping, and a pump of a first vacuum system disposed in a virtual region according to a user input, simulate the first vacuum system based on the specifications of the chamber, piping, and pump, display a first simulation result showing a time to reach a target pressure from a chamber start pressure and a second simulation result showing a change in chamber vacuum according to a change in gas load (or flow), as results of the simulation, and select a pump capacity (peak pumping speed) that satisfies all of the process conditions for each of the first simulation result and the second simulation result, wherein the process conditions comprise first process conditions related to the first simulation result and second process conditions related to the second simulation result.

A method for selecting a pump of an optimal capacity in a vacuum system including a chamber, piping, and a pump in accordance with one embodiment of the present disclosure comprises: (a) setting specifications and process conditions of a chamber, piping, and a pump of a first vacuum system disposed in a virtual region according to a user input; (b) simulating the first vacuum system based on the specifications of the chamber, piping, and pump; (c) displaying a first simulation result showing a time to reach a target pressure from a chamber start pressure and a second simulation result showing a change in chamber vacuum according to a change in gas load (or flow), as results of the simulation; and (d) selecting a pump capacity (peak pumping speed) that satisfies all of the process conditions for each of the first simulation result and the second simulation result, wherein the process conditions comprise first process conditions related to the first simulation result and second process conditions related to the second simulation result.

Moreover, an apparatus for optimized design of a vacuum system including a chamber, piping, and a pump in accordance with one embodiment of the present disclosure comprises: one or more processors; and a memory configured to be connected with the processors, wherein the memory stores program instructions executable by the processors so as to set specifications and process conditions of a chamber, piping, and a pump of a first vacuum system disposed in a virtual region according to a user input, simulate the first vacuum system based on the specifications of the chamber, piping, and pump, display a first simulation result showing a time to reach a target pressure from a chamber start pressure and a second simulation result showing a change in chamber vacuum according to a change in gas load (or flow), as results of the simulation, and select a pump capacity (peak pumping speed) that satisfies all of the process conditions for each of the first simulation result and the second simulation result, wherein the process conditions comprise first process conditions related to the first simulation result and second process conditions related to the second simulation result.

In a method for displaying a design screen of a vacuum system in accordance with one embodiment of the present disclosure for achieving the objects described above, the method for displaying a design screen of a vacuum system including a chamber, piping, and a pump, comprises: (a) displaying a first vacuum system implemented in a virtual region on a screen according to a user input; (b) simulating the first vacuum system, and displaying on the screen a first simulation result (hereinafter referred to as a ‘(1-1)th simulation result’) and a second simulation result (hereinafter referred to as a ‘(1-2)th simulation result’), which are results of the corresponding simulation; (c) displaying on the screen a second vacuum system implemented by reflecting piping or a pump having changed specifications in the first vacuum system according to a user input; and (d) simulating the second vacuum system, and displaying on the screen a first simulation result (hereinafter referred to as a ‘(2-1)th simulation result’) and a second simulation result (hereinafter referred to as a ‘(2-2)th simulation result’), which are results of the corresponding simulation, wherein specifications and process conditions of the chambers of the first vacuum system and the second vacuum system are identical, and process conditions are displayed, respectively, on the (1-1)th simulation result, the (1-2)th simulation result, the (2-1)th simulation result, and the (2-2)th simulation result.

In the foregoing, said step (d) accumulates and displays the (1-1)th simulation result and the (2-1)th simulation result together, and accumulates and displays the (2-1)th simulation result and the (2-2)th simulation result together.

In the foregoing, the specifications and process conditions of the chambers of the first vacuum system and the second vacuum system are identical.

In the foregoing, (e) if there exist simulation results of an n-th vacuum system (n >2), results of at least two simulations selected by a user are accumulated and displayed together on the screen.

In the foregoing, the first vacuum system and the second vacuum system are disposed in different regions in the screen, respectively, and the respective disposed regions are adjacent to each other, and the (1-1)th simulation result and the (2-1)th simulation result, and the (2-1)th simulation result and the (2-2)th simulation result are disposed in the same region in the screen.

An apparatus for displaying a design screen of a vacuum system including a chamber, piping, and a pump in accordance with one embodiment of the present disclosure comprises: one or more processors; and a memory configured to be connected with the processors, wherein the memory stores program instructions executable by the processors so as to display a first vacuum system implemented in a virtual region in a first region of a screen according to a user input, simulate the first vacuum system and display in a second region of the screen a first simulation result (hereinafter referred to as a ‘(1-1)th simulation result’) and a second simulation result (hereinafter referred to as a ‘(1-2)th simulation result’) that are results of the corresponding simulation, display in a third region of the screen a second vacuum system implemented by reflecting piping or a pump having changed specifications in the first vacuum system according to a user input, and simulate the second vacuum system and display in a fourth region of the screen a first simulation result (hereinafter referred to as a ‘(2-1)th simulation result’) and a second simulation result (hereinafter referred to as a ‘(2-2)th simulation result’) that are results of the corresponding simulation.

The memory stores program instructions executable by the processors so as to accumulate and display results of at least two simulations selected by a user together on the screen if there exist simulation results of an n-th vacuum system (n>2).

### Effects of the Disclosure

The present disclosure has the advantage of being able to provide a vacuum system design program by visual modeling and provide simulation graphs so as to determine suitability for an implemented vacuum system.

In addition, since simulation graphs can be provided for each system by a user selection, there is an effect of providing intuitive design results and enhancing user convenience.

Further, the configuration and specifications of a vacuum system can be set conveniently by visual modeling when designing the vacuum system, and simulation results can be provided so that pump specifications among the configurations of the designed vacuum system can be replaced with optimal specifications that satisfy process conditions.

Moreover, since it is not necessary to use a pump with unnecessarily excessive capacity when designing a vacuum system, costs can be saved when constructing the vacuum system.

Furthermore, there is an advantage of being able to provide a vacuum system design program including visual modeling of a vacuum system consisting of piping, pumps, and chambers, and provide a vacuum system modeled for a vacuum system implemented on the program and simulation result graphs so as to display them intuitively on a split screen.

In addition, by providing a user interface so as to be provided with systems, graph placement positions, option changes, and filtering functions according to a user selection by using the vacuum system design program, there is an effect of enhancing user convenience.

### BRIEF DESCRIPTION OF THE DRAWINGS

FIG. 1 is a configuration block diagram for providing a vacuum system design in accordance with one embodiment of the present disclosure;

FIGS. 2a and 2b are flowcharts illustrating a vacuum system design process in accordance with one embodiment of the present disclosure;

FIG. 3 is a flowchart illustrating a process of selecting a pump of an optimal capacity when designing a vacuum system in accordance with one embodiment of the present disclosure;

FIG. 4 is a diagram illustrating simulation results in accordance with one embodiment of the present disclosure;

FIG. 5 is a diagram illustrating simulation results in accordance with another embodiment of the present disclosure; and

FIGS. 6, 7a, and 7b are diagrams illustrating the configuration of a design screen of a vacuum system in accordance with one embodiment of the present disclosure.

### DETAILED DESCRIPTION OF EMBODIMENTS

Hereinafter, specific embodiments of the present disclosure will be described in detail with reference to the drawings. However, the idea of the present disclosure is not limited to the embodiments presented, and those of ordinary skill in the art who understands the idea of the present disclosure will be able to readily suggest other retrogressive inventions or other embodiments that fall within the scope of the idea of the present disclosure through addition, change, deletion, or the like of other components within the scope of the same idea, which will also be intended to be included in the scope of the idea of the present disclosure. Further, components having the same function within the scope of the same idea appearing in the drawings of each embodiment will be described using the same reference numerals.

FIG. 1 is a configuration block diagram for a vacuum system design in accordance with one embodiment of the present disclosure.

The vacuum system design in accordance with one embodiment of the present disclosure may be performed by a ‘vacuum system design program.’ The vacuum system design program may be present in a server 30 and be provided in a web-based form as one embodiment, and in this case, a user can design a vacuum system by accessing a website provided by the server 30 by using a user terminal 10. As another embodiment, the vacuum system design program may be distributed and installed in the user terminal 10 and the server 30. For example, parts that use less resources, such as the user interface of the vacuum system design program, may be provided by the user terminal 10, and parts that use more resources, such as a database, may be present in the server 30. As yet another embodiment, in the vacuum system design program, all components including a database may be present in the user terminal 10. In this case, the user terminal 10 does not need to be connected online for the vacuum system design, and may be physically connected to an external storage device in which an update file is stored so that the update of a program can be performed as needed. In the following, an embodiment in which the vacuum system design program is present in the server 30 and the vacuum system design to be described below is provided in a web-based form by the server 30 will be described.

For reference, the server 30 may include one or more processors and a memory configured to be connected with the processors, and program instructions executable by the processor for performing the operations of the server 30 to be described below may be stored in the memory. In addition, the server 30 may further include a communication unit for communicating with the user terminal 10.

As one embodiment of the present disclosure, the server 30 may allow components such as a chamber, piping, and a pump to be disposed in a 2D or 3D virtual region and specifications of each component to be set, thereby implementing (designing) a vacuum system.

Here, the ‘specifications’ may include the shape (e.g., cuboid, cylinder, etc.) and volume, start pressure, target pressure, gas load (or gas flow), process pressure, etc., in the case of a chamber. For reference, the ‘start pressure’ and the ‘target pressure’ may be included in ‘process conditions’ to be described later.

In the case of piping, the types and their respective lengths, inner diameters, angles, etc., according to the shapes, such as pipes, bends (bends/elbows/miters), reducers, etc., may be included in the specifications.

In the case of a pump, the pump size, inlet size and location, pumping speed, and the like may be included in the specifications.

The server 30 may simulate a vacuum system designed based on the specifications of the components (chamber, piping, pump, etc.) of the vacuum system described above, and determine whether the simulation results satisfy or dissatisfy the process conditions. In the present disclosure, the ‘process conditions’ may include first process conditions including a start pressure of the chamber, a target pressure thereof, and a time (required) to reach the target pressure from the start pressure of the chamber, and second process conditions including a process pressure at a maximum gas load (or gas flow), a gas load at a maximum process pressure, and a gas load at a minimum process pressure. The first process conditions and the second process conditions may be set by the user, and the server 30 may provide relevant information so as to be able to extract piping having inefficient specifications out of the respective components (pipes, bends, reducers, etc.) of the entire piping currently implemented in the vacuum system, determine whether the pump currently implemented in the vacuum system falls within inefficient specifications, and enable the user to select a pump having optimal specifications (e.g., capacity) in the corresponding vacuum system by using a vacuum design program in accordance with one embodiment of the present disclosure. Here, ‘inefficient’ may mean the use of piping of low efficiency or a pump of excessively high specifications even if the first process conditions and the second process conditions are satisfied.

In order to optimize the piping, the server may display the piping having inefficient specifications in the vacuum system designed by the user by using particular colors, and the user may try to change the specifications of the inefficient piping to piping specifications of higher efficiency (bends with gentle angles, expansion of the pipe inner diameter, gradually reduced/expanded pipes).

In this case, if a particular event (for example, positioning the mouse cursor or the like) by a user input occurs in the piping displayed as inefficient specifications, the server may display guide information including specifications that can be changed in the corresponding piping, information on the problems with the corresponding piping, or the like.

The server may perform the simulation again by reflecting the specifications of the corresponding piping changed by the user to the existing vacuum system, and compare the process conditions with the simulation results. Piping having inefficient specifications may be extracted again, and this process may be repeated several times.

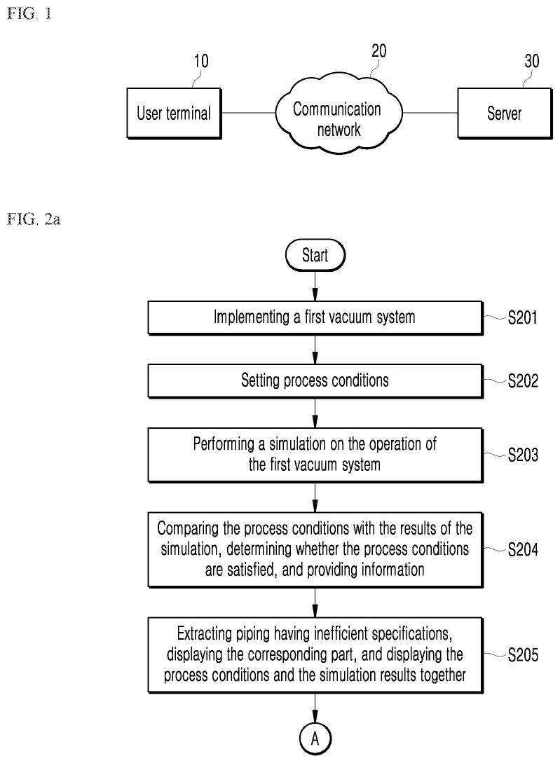

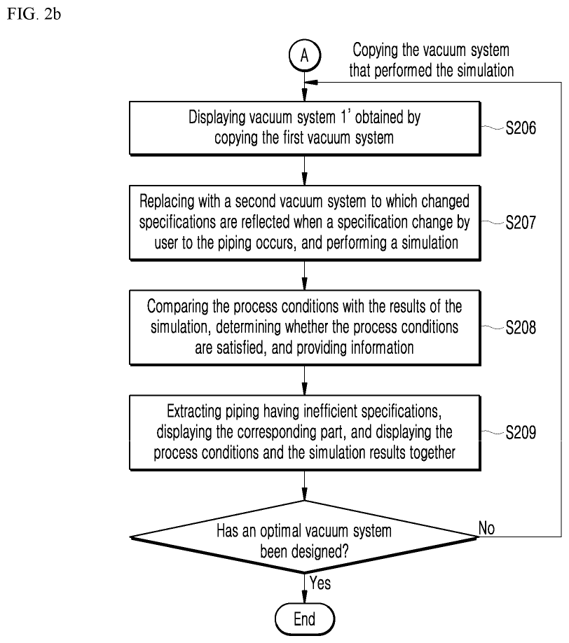

In the following, a process of optimizing piping when designing a vacuum system will be described in detail with reference to FIGS. 2a and 2b.

FIGS. 2a and 2b are flowcharts illustrating a vacuum system design process in accordance with one embodiment of the present disclosure, which may be performed by the server 30 shown in FIG. 1.

The server implements a vacuum system by disposing a chamber, piping, and a pump in a virtual region according to a user input (S201).

At this time, the server may implement the system by reflecting the specifications of each component entered or selected by the user. For reference, the user can select icons provided in advance when selecting or entering each component and specifications of the vacuum system, and can set the size or position by using the mouse drag. Of course, the user may directly enter the numerical values as well.

After S201, the server sets the process conditions of the vacuum system according to a user input (S202).

For reference, although setting the process conditions of the vacuum system has been described as being performed after S201, they may be set together when setting the specifications of each component of the vacuum system in S201, depending on the embodiment.

After S202, the server performs a simulation based on the components and the respective specifications of the vacuum system designed in S201 (hereinafter referred to as a ‘first vacuum system’) (S203).

For reference, the server may also perform steps S201 to S203 described above by invoking an existing vacuum system designed previously into the virtual region.

After S203, the server compares the process conditions set in S202 with the results of the simulation performed in S203, determines whether the process conditions are satisfied or dissatisfied, and provides information thereon (S204).

After S204, the server compares the conductance between the respective components (pipes, bends, reducers, etc.) of the entire piping with one another, extracts piping having inefficient specifications, displays it on the corresponding part of the first vacuum system, and displays the results of the first vacuum simulation together with the process conditions in the form of graphs in a separate adjacent region (S205).

Here, the piping having inefficient specifications may be displayed using particular colors, and if the mouse cursor of the user is positioned on the corresponding piping, the server may display guide information, including information on the problems with the corresponding piping, specifications that can be changed in the corresponding piping, or the like.

After S205, the server copies the first vacuum system according to a user input, and displays it next to a first vacuum system in which the piping having inefficient specifications of S204 is displayed (hereinafter referred to as vacuum system 1′) (S206).

This is to facilitate comparison between the vacuum system having an inefficient part and the vacuum system in which the corresponding part has been changed (improved).

After S206, if a specification change by the user to the piping among the chamber, piping, and pump of the vacuum system 1′ occurs by the user, the server replaces the vacuum system 1′ with a second vacuum system to which the specifications changed by the user have been reflected, displays the second vacuum system, and performs a simulation based on the components and the respective specifications of the second vacuum system (for the piping, the specifications changed by the user have been reflected) (S207).

After S207, the server compares the process conditions set in S202 with the results of the simulation performed in S207, determines whether the process conditions are satisfied or dissatisfied, and provides information thereon (S208).

After S208, the server compares the conductance between the respective components (pipes, bends, reducers, etc.) of the entire piping with one another, extracts piping having inefficient specifications, displays it on the corresponding part of the second vacuum system, and displays the results of the second vacuum simulation together with the process conditions in the form of graphs in a separate adjacent region (S209).

Here, the server may accumulate and display the results of the second vacuum simulation on the results of the first simulation displayed together with the process conditions.

After S209, the server may repetitively perform the steps described above according to a user input until the vacuum system designed by the user satisfies the process conditions.

When the vacuum system design program is run, conditions may be entered in order to design one's desired vacuum system, and simulation results of the vacuum system for the conditions entered may be provided in the form of graphs.

A more detailed description of a process of designing a vacuum system and performing a simulation by using the vacuum system design program described above is as follows.

The chamber is first configured, piping is selected, piping connections are determined, the pump is configured, and then, it is subject to the process of deriving simulation results for the vacuum system including the chamber, pump, and piping that are finally connected.

First, in the process of configuring the chamber, the shapes of various types of chambers implemented and provided by 3D modeling are determined by a user selection, and the size, volume, surface area, and the like may be set with an interface such as a drag-and-drop method.

In addition, ‘process conditions,’ including one or more of a start pressure of the chamber, a target pressure thereof, and a time (required) to reach the target pressure from the start pressure, a process pressure at a maximum gas load, a gas load at a maximum process pressure, and a gas load at a minimum process pressure, may be entered and set by the user.

Next, the selection of the piping and the piping connections may be made, appropriate piping and piping connections may be selected out of the shapes of various types of piping and piping connections implemented and provided by 3D modeling similarly to the chamber configuration, and at this time, it is possible to provide a function of preferentially displaying the piping and piping connections that can be connected to the chamber being worked on.

In addition, the specifications of the piping, such as the length, thickness, and diameter of the piping, may be determined, and a bending (bent) angle, specifications of upper and lower parts, and the like may be determined separately, depending on the shape of the piping. The chamber, the piping, and the piping connections may be stored in a database of the server by their types and provided for the user to select a type to model. The types of piping and piping connections to be provided may include, for example, elbows, bends, miters, reducers, and the like in addition to straight pipes. Further, the piping connections may include branch connections, flanges, plugs, caps, blind flanges, or the like.

Similarly, pumps may also be provided by type, a pump may be determined by a user selection, and various specifications of the pump (size, location, pumping speed, etc.) may also be provided as input variables.

After selecting all of the chamber, pump, piping, and piping connections, each connection point may be realized visually by an automatic connection function, and at this time, by automatically calculating the piping conductance by shape and pressure for the piping and piping connections and displaying them in different colors through relative comparison, the user is allowed to easily determine inefficient piping or piping connections. For example, the piping efficiency may be displayed in the order of blue, yellow, orange, and red as it moves from the highest to the lowest, or may be displayed in a single color from no color (or white) to darker colors gradually.

The piping conductance calculation algorithm for each shape may vary in the result values depending on the piping shape or pressure.

In addition, a simulation result graph showing the time to reach the target pressure from the start pressure of the chamber and a simulation result graph showing the change in chamber vacuum according to the change in gas load (or gas flow) can be derived, and the user can visually check if optimized by comparing the simulation result graphs before/after system improvements with the process conditions.

Further, since simulation results for each system configuration can be intuitively compared on graphs, the degree of change can be easily checked.

Moreover, the vacuum chamber system designed by connecting the chamber, pump, and piping can be implemented in plurality, it can be stored individually in the database of the user terminal or the server by a user selection for the plurality of systems, functions such as system copy, edit, delete, and the like can be provided, and simulation graphs can be provided for each system by a user selection, and thus, there is an effect of providing intuitive design results and enhancing user convenience.

Furthermore, as the server provides the vacuum system design program in a web-based manner, personal information for login authentication, a number of vacuum chamber systems designed for each user, personal payment details for providing paid services, and the like can be stored and managed in a web-based database, and at this time, a separate authentication unit (not shown) may be included for security.

The authentication unit may encrypt and store personal information received from the user terminal, vacuum chamber system information, personal payment details, and the like in a database.

Here, the personal information may include unique key information encrypted for user login authentication in addition to user personal information, and authentication may be performed depending on whether this unique key matches a unique key stored in the database.

Furthermore, the authentication unit may build a blockchain network in connection with a number of blockchain servers, generate a public key and a private key through the pre-built internal blockchain network, convert them into hash values, and store them in a distributed manner, and user authentication may be performed based on the public key stored in a distributed manner and the user personal information.

Moreover, the authentication unit may receive individual unique user information along with a public key from a number of user terminals and generate user certificates, respectively, including a hash value for the user information, and the storage method for each user certificate may be made by a Merkle tree structure.

For example, each user certificate (transaction) is stored including a hash value in the lowest child nodes, and is hashed and stored in the Merkle root (parent node), which is the highest level of the Merkle tree, so that the hash value is shared with intermediate nodes on the path that follows the lowest child nodes.

Through this, when determining the authenticity of the stored user certificate, the user certificate copied to the personal user terminal is compared with the user certificate in the database, which is done by comparing only hash values that have been hashed along the path of the Merkle tree.

At this time, because it is not necessary to perform comparison operations on the blocks of all nodes as the comparison operations are performed on the path of the Merkle tree, authenticity can be determined with a relatively light amount of operation, falsification of transactions can be detected easily and quickly, and transactions can be easily verified even in portable user terminals with small capacities.

Furthermore, the vacuum system design program may be provided in the form of a web-based/desktop-based computer program executable on a computer or an application implemented on a portable smartphone, phablet phone, or the like.

When the optimization of the piping in the current vacuum system is completed with the operation of the server 30 as described above, the server 30 may provide information so that a pump having optimal specifications, i.e., a pump of an optimal capacity, is selected with the operation to be described below.

In the following, it is assumed that the optimization of the piping in the current vacuum system is completed using the vacuum design program in accordance with one embodiment of the present disclosure, and the details of selecting a pump having optimal specifications, i.e., a pump of an optimal capacity after the optimization of the piping is completed will be described.

The server 30 implements a vacuum system by disposing a chamber, piping, and a pump in a virtual region according to a user input (S301).

At this time, the server 30 may implement the system by reflecting the specifications of each component entered or selected by the user. For reference, the user can select icons provided in advance when selecting or entering each component and specifications of the vacuum system, and can set the size or position by using the mouse drag. Of course, the user may directly enter the numerical values as well.

After S301, the server 30 sets first process conditions and second process conditions of the vacuum system according to a user input (S302).

Here, the first process conditions may include a start pressure of the chamber, a target pressure thereof, and a time (required) to reach the target pressure from the start pressure of the chamber, and the second process conditions may include a process pressure at a maximum gas load (or gas flow), a gas load at a maximum process pressure, and a gas load at a minimum process pressure.

For reference, although setting the process conditions of the vacuum system has been described as being performed after S301, they may be set together when setting the specifications of each component of the vacuum system in S301, depending on the embodiment.

In addition, although the description of the process of optimizing the piping is omitted in S301, it is assumed that the optimization of the piping is completed through the process described above.

After S302, the server 30 performs a simulation based on the components and the respective specifications of the vacuum system designed in S301 (hereinafter referred to as a ‘first vacuum system’) (S303).

For reference, the server 30 may also perform steps S301 to S303 described above by invoking an existing vacuum system designed previously into the virtual region.

After S303, the server 30 provides a ‘first simulation result’ showing the time to reach the target pressure from the start pressure of the chamber and a ‘second simulation result’ showing the change in chamber vacuum according to the change in gas load (or flow) to the user terminal 10 as the results of the simulation in S302, causing them to be displayed on the screen (S304).

Here, the first simulation result may be related to the first process conditions, and the second simulation result may be related to the second process conditions. The server 30 may display the first process conditions together on the first simulation result and the second process conditions together on the second simulation result in S304.

At this time, the server 30 may provide the process conditions and the simulation results in one or more of graphs, tables, and text. For example, by displaying the simulation results in a graph and displaying the process conditions together on that graph, the user can intuitively understand whether the vacuum system designed by him/herself satisfies or does not satisfy the process conditions.

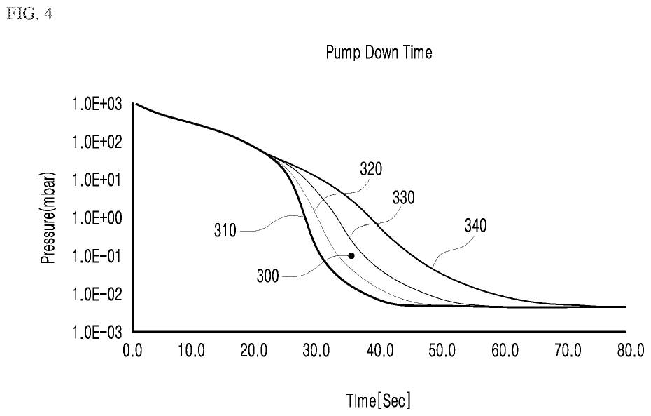

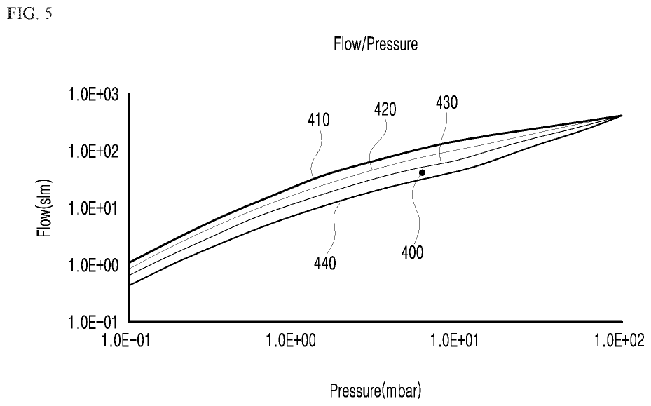

The server 30 may provide the process conditions and the simulation results in one or more of graphs, tables, and text. For example, by displaying the simulation results in a graph and displaying the process conditions together on that graph, the user can intuitively understand whether the vacuum system designed by him/herself satisfies or does not satisfy the process conditions. Details regarding this is shown in FIGS. 4 and 5, respectively.

After S304, the server 30 selects a pump capacity (peak pumping speed) that satisfies the first process conditions in the first simulation result and the second process conditions in the second simulation result, i.e., that satisfies all the process conditions for each of the first simulation result and the second simulation result (S305).

Here, the pump capacity (peak pumping speed) selected by the server 30 may not be a specification of a pump that actually exists (is sold). That is, if a pump having the same capacity as the pump capacity selected by the server 30 actually exists (is sold), a pump of the corresponding capacity can be purchased and applied to the vacuum system. However, if the same capacity as the pump capacity selected by the server 30 does not actually exist (is not sold), the user can select a pump (hereinafter referred to as an ‘alternative pump’) having a capacity closest to the corresponding capacity (more specifically, a capacity that is greater than and closest to the corresponding capacity). In other words, the capacity of the alternative pump selected by the user may be equal to or greater than the pump capacity selected by the server 30.

A detailed description of S305 will be described later with reference to FIGS. 4 and 5.

After S305, the server 30 copies the first vacuum system according to a user input, and displays it next to a first vacuum system on the screen (hereinafter referred to as vacuum system 1′)

After S306, if the pump capacity of the vacuum system 1′ is changed to the capacity of the alternative pump by the user, the server 30 replaces the vacuum system 1′ with a second vacuum system to which the capacity of the alternative pump has been reflected, displays the second vacuum system, and performs a simulation based on the components and the respective specifications of the second vacuum system (S307).

After S307, the server 30 compares the first process conditions and the second process conditions set in S302 with the results of the simulation (first simulation result and second simulation result) performed in S307, and performs S304 and subsequent processes (S308).

The server 30 may repetitively perform the steps described above according to a user input until an optimal pump specification is selected in the range where the vacuum system designed by the user satisfies both the first process conditions and the second process conditions.

Here, until an optimal vacuum system is designed, the server 30 may display the simulation results together with the process conditions, and may provide the simulation results together so that the respective simulation results can be compared with each other in the process of performing the simulation again by changing the pump capacity of the corresponding vacuum system to an alternative pump capacity by the user. For example, a first simulation result (hereinafter referred to as a ‘(1-1)th simulation result’) and a second simulation result (hereinafter referred to as ‘(1-2)th simulation result’) that are the simulation results of the first vacuum system may be displayed on the screen together with a first simulation result (hereinafter referred to as a ‘(2-1)th simulation result’) and a second simulation result (hereinafter referred to as a ‘(2-2)th simulation result’) that are the simulation results of the second vacuum system. At this time, the (1-1)th simulation result and the (2-1)th simulation result may be displayed on the screen side by side, or superimposed (accumulated) with each other and displayed on the screen. Of course, the (1-2)th simulation result and the (2-2)th simulation result may also be displayed on the screen in the same way.

Meanwhile, the server may provide the process conditions and the simulation results in one or more of graphs, tables, and text. For example, by displaying the simulation results in a graph and displaying the process conditions together on that graph, the user can intuitively understand whether the vacuum system designed by him/herself satisfies or does not satisfy the process conditions.

Further, until an optimal vacuum system is designed, the server may compare the simulation results with the process conditions and extract and display piping having inefficient specifications, or select the pump capacity for optimization and provide the corresponding information, and may provide the simulation results together so that the respective simulation results can be compared with each other in the process of performing the simulation again if the user changes the specification of the corresponding piping or the capacity of the pump. At this time, the number of simulation results provided together to allow for comparison may be set.

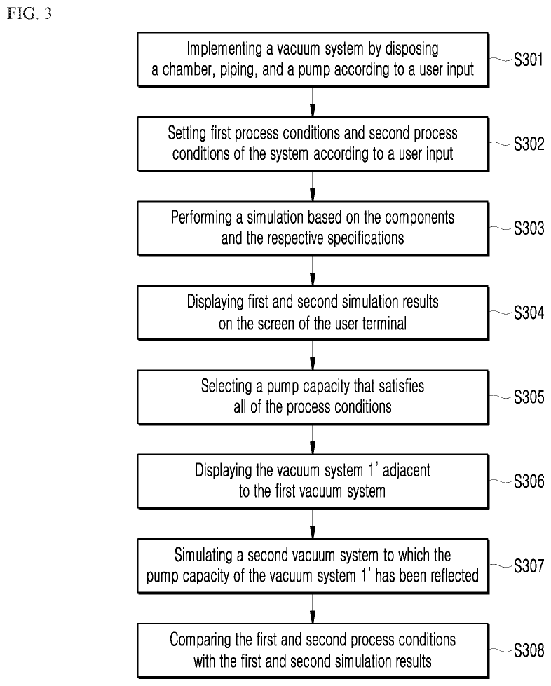

For reference, the processes shown in FIGS. 2a, 2b, and 3 are put together and summarized in short as follows.

Implementing the first vacuum system→Simulating the first vacuum system→Evaluating the efficiency of the piping from the first simulation result→Copying the first vacuum system and implementing the second vacuum system in which the inefficient piping has been changed→Simulating the second vacuum system and optimizing the piping (simulation results can be compared)→Evaluating the efficiency of the pump from the simulation results of the second vacuum system→Copying the second vacuum system and implementing the third vacuum system to which the pump with the changed capacity has been reflected→Simulating the third vacuum system and optimizing the pump (simulation results can be compared).

FIGS. 4 and 5 are diagrams illustrating simulation results in accordance with embodiments of the present disclosure.

The simulation result of FIG. 4 is a first simulation result obtained by simulating the first vacuum system, and shows the time to reach the chamber target pressure (pump down time) of the vacuum system designed by the user in graphs. Here, the first process conditions (the start pressure of the chamber, the target pressure thereof, and the time (required) to reach the target pressure from the start pressure of the chamber) 300 are shown along with graphs.

The simulation result of FIG. 5 is a second simulation result obtained by simulating the first vacuum system, and shows chamber pressure changes (flow/pressure) according to gas loads in graphs.

Here, the second process conditions (the process pressure at a maximum gas load (or gas flow), the gas load at a maximum process pressure, and the gas load at a minimum process pressure) 400 are shown along with graphs.

When providing (displaying) the first simulation result and the second simulation result, the server 30 may display the pumping speed i.e., the pump capacity, of the first vacuum system designed by the user as a reference (100%) 310 and 410.

Looking first into FIG. 4, the current pump capacity (hereinafter referred to as ‘reference pump capacity’) 310 of the first vacuum system designed by the user is in a state that satisfies the first process conditions 300. Even if the reference pump capacity 310 is applied to an actual vacuum system, there is no problem in using it because it sufficiently satisfies the first process conditions 300, but since this results in using a pump with an unnecessarily excessive capacity, it is necessary to select a pump with a lower capacity than the current pump capacity in order to select an optimal pump capacity.

In this case, the server 30 may calculate the pump capacity by decreasing the pump capacity by preset proportions (70%, 50%, 30%) from the reference pump capacity, and display them in graphs 320, 330, and 340, respectively. Of course, the preset proportions are merely one embodiment and may be set to any number of different proportions. Here, the result of the actual simulation among the graphs shown as the first simulation result is only one, the reference pump capacity 310, and the rest of the graphs 320, 330, and 340 are the results calculated by applying preset proportions (70%, 50%, 30%) in the server 30 based on the reference pump capacity 310. In other words, since the server 30 does not need to perform a total of four simulations for the first vacuum system in order to obtain the four graphs 310, 320, 330, and 340 shown as the first simulation result, there is an advantage of reducing the burden on driving the vacuum system design program.

The server 30 may select a pump capacity of 70% 320 relative to the reference pump capacity 310 as the pump capacity that satisfies the first process conditions 300 in the first simulation result shown in FIG. 4.

On the other hand, the reference pump capacity 410 in the second simulation result of FIG. 5 is in a state that satisfies the second process conditions 400. Even if the reference pump capacity 410 is applied to an actual vacuum system, there is no problem in using it because it sufficiently satisfies the second process conditions 400, but since this case also results in using a pump with an unnecessarily excessive capacity, it is necessary to select a pump with a lower capacity than the current pump capacity in order to select an optimal pump capacity. The server 30 may calculate the pump capacity by decreasing the pump capacity by preset proportions (70%, 50%, 30%) from the reference pump capacity 410, and display them in graphs 420, 430, and 440, respectively. Here again, the result of the actual simulation among the graphs shown as the second simulation result is only one, the reference pump capacity 410, and the rest of the graphs 420, 430, and 440 are the results calculated by applying preset proportions (70%, 50%, 30%) in the server 30 based on the reference pump capacity 410.

The server 30 may select pump capacities of 70% 420 and 50% 430 relative to the reference pump capacity 410 as the pump capacities that satisfy the second process conditions 400 in the second simulation result shown in FIG. 5.

In summary, when the first simulation result of FIG. 4 and the second simulation result of FIG. 5 satisfied the first process conditions and the second process conditions, respectively, the server 30 decreased the pump capacity at certain proportions and selected respective pump capacities that matched the respective process conditions. That is, a pump capacity of 70% 320 relative to the reference pump capacity 310 was selected in the first simulation result, and pump capacities of 70% 420 and 50% 430 relative to the reference pump capacity 410 were selected in the second simulation result. After that, the server 30 may select a pump capacity of 70% that satisfies all out of the selected pump capacities as the optimal pump capacity, and the user may find a pump having a capacity equal to or closest to 70% (greater than 70%) of the reference pump capacity from pumps that actually exist (are sold) and select it as the alternative pump, and input the actual specifications of the selected alternative pump into the first vacuum system, thereby the server 30 may simulate the second vacuum system to which the alternative pump has been reflected.

For reference, the pumping speed has been described as the pump capacity, but the server 30 may select the peak out of a number of pumping speeds when selecting a pump capacity that satisfies all of the process conditions.

The case where the first simulation result and the second simulation result satisfy all of the respective process conditions has been described in the embodiments of FIGS. 4 and 5, but if any of the first simulation result and the second simulation result does not satisfy one or more of the respective process conditions, the server 30 may increase the reference pump capacity at certain proportions and select respective pump capacities that are close to the respective process conditions.

At this time, the server 30 may select a larger pump capacity out of the respective selected pump capacities as the optimal pump capacity.

As another embodiment of selecting as the optimal pump capacity, if the first simulation result and the second simulation result satisfy all of the respective process conditions, the server 30 may select respective pump capacities that match the respective process conditions by decreasing the capacity from the reference pump capacity, and select a larger pump capacity out of the respective selected pump capacities as the optimal pump capacity. That is, in selecting the optimal pump capacity that satisfies all the process conditions, the pump capacity that matches the process conditions is immediately calculated and provided. If any of the first simulation result and the second simulation result does not satisfy one or more of the respective process conditions, the server 30 may increase the pump capacity and select respective pump capacities that match the respective process conditions, and select a larger pump capacity out of the respective selected pump capacities as the optimal pump capacity.

For reference, prior to performing the processes described above, the user terminal 10 may attempt to log in to a website for vacuum system design provided by the server 30. An initial membership registration process is required for login authentication, and the vacuum system program may be available temporarily by personal information authentication when proceeding as a non-member, but the benefits provided to members, such as discounts, may be limited.

For example, the server 30 may provide a vacuum system design program service on a membership basis and also provide a trial version form and a full version with payment, and when using the full version service, payments may be made for each login, or a fixed-term payment method may be employed.

In addition, the login authentication may proceed by matching the personal information provided at the time of initial membership registration, and to this end, the server can encrypt and store the personal information in the database.

Once the login authentication is completed, the vacuum system design program is provided in a web-based manner via a communication network 20, and to this end, the user terminal may have a communication protocol that allows connection to the communication network built therein as it needs to connect to the server periodically via the communication network.

The user terminal may include, for example, a desktop computer, a laptop computer, a tablet PC, a tablet phone, a smartphone, and the like.

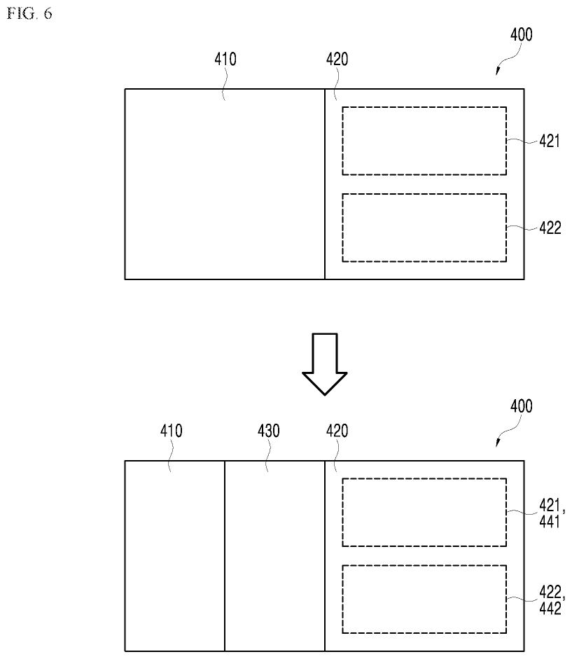

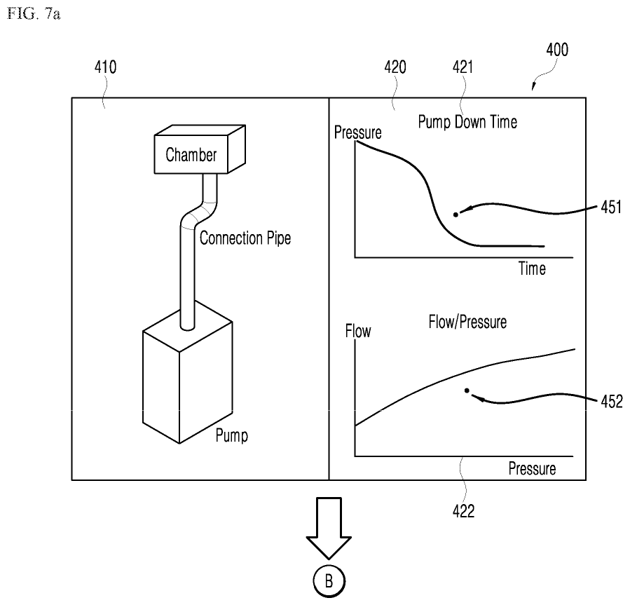

FIG. 6 is a diagram illustrating the configuration of a design screen of a vacuum system in accordance with one embodiment of the present disclosure. For reference, FIG. 6 is a screen provided in the process of optimizing the piping in the vacuum system.

A first vacuum system implemented by a user may be displayed in a first region 410 of the screen 400, and a (1-1)th simulation result 421 and a (1-2)th simulation result 422 may be displayed as simulation results in a second region 420 of the screen after the simulation of the first vacuum system.

Here, the (1-1)th simulation result 421 is a graph showing the time to reach the target pressure from the start pressure of the chamber in the first vacuum system, and the (1-2)th simulation result 422 is a graph showing the chamber pressure at the time of gas load (flow) in the first vacuum system.

After that, when a specification change by the user to the piping occurs, a second vacuum system to which the specification change by the user to the piping has been reflected may be placed and displayed in a third region 430, which is a spare region created by dividing the first region 410 of the screen. After the simulation of the second vacuum system, a (2-1)th simulation result 441 and a (2-2)th simulation result 442 may be displayed in the second region 420 as the simulation results.

Here, the (2-1)th simulation result 441 is a graph showing the time to reach the target pressure from the start pressure of the chamber in the second vacuum system, and the (2-2)th simulation result 442 is a graph showing the chamber pressure at the time of gas load (flow) in the second vacuum system. And for the (1-1)th simulation result 421 and the (2-1)th simulation result 441, and the (1-2)th simulation result 422 and the (2-2)th simulation result 442, the respective results may be accumulated and displayed.

Depending on the embodiment, the (2-1)th simulation result 441 and the (2-2)th simulation result 442 may be displayed in a fourth region (not shown) that is different from the second region 420, and the fourth region (not shown) may be a spare region created by dividing the second region 420.

If the configuration specifications of the vacuum system are changed by the user, there may exist an ‘n-th’ vacuum system to which the changed specifications have been reflected. In this case, said ‘n’ may be limited to a predetermined number of times (e.g., ‘6’), and a particular number of vacuum systems that have been simulated most recently and the simulation results of the corresponding vacuum systems may be displayed on the screen. Of course, depending on the embodiment, particular vacuum systems selected by the user and the simulation results of the corresponding vacuum systems may be displayed. At this time, the simulation results of the vacuum systems to be displayed together on the screen may be accumulated and displayed together in the form of graphs on one coordinate in the same region. For reference, the ‘user selection’ in the ‘particular vacuum systems selected by the user’ may be an indirect selection through a filtering process by a user input, or a direct selection using an input means such as a mouse or keyboard or the user's touch.

The design screen of the vacuum system as shown in FIG. 6 may be provided, in a default form, with a screen configuration in which the screen on which the vacuum system is designed is displayed in the left region, and the simulation results of the vacuum system are displayed in a side view form on the right region of the screen. In addition, such a screen configuration may be set in the form of a top/down view that is arranged up and down according to user settings, or may be provided with a user interface (UI) so that the location can be moved freely on the screen through the dragging in and out by the user.

Through the screen configuration (arrangement) described above, the user can intuitively compare the simulation results before and after the improvement of the vacuum system and whether the efficiency of the piping is improved.

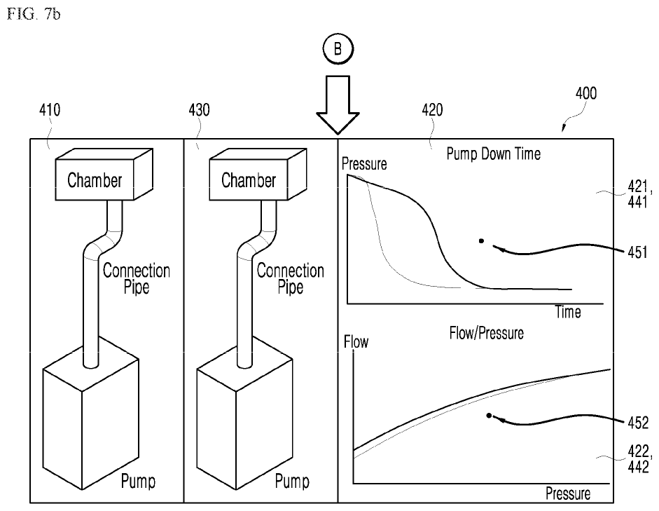

FIGS. 7a and 7b are diagrams illustrating an actual configuration of a design screen of a vacuum system in accordance with one embodiment of the present disclosure, and are screens provided in the process of improving the piping efficiency in the vacuum system.

As described with reference to FIG. 6, a first vacuum system implemented by a user is displayed in a first region 410 of the screen 400, and a (1-1)th simulation result 421 and a (1-2)th simulation result 422 are displayed in a second region 420 of the screen after the simulation of the first vacuum system. And a second vacuum system to which the specification change by the user to the piping has been reflected is displayed in a third region 430, and after the simulation of the second vacuum system, a (2-1)th simulation result 441 and a (2-2)th simulation result 442 are displayed as simulation results in a fourth region 440. At this time, by having the process conditions of the second vacuum system displayed together, the user will be able to intuitively check whether the corresponding simulation results satisfy the respective process conditions 451 and 452.

In the embodiment of FIGS. 7a and 7b, the second region 420 and the fourth region 440 of the screen are superimposed on each other. That is, since the same simulation results are displayed together in the form of graphs superimposed on one coordinate, the user can intuitively compare the simulation results before and after the improvement of the vacuum system and whether the efficiency of the piping is improved.

1. A method for designing a vacuum system including a chamber, piping, and a pump, comprising:
setting process conditions (including a start pressure of the chamber, a target pressure thereof, and a time to reach the target pressure) of a first vacuum system disposed in a virtual region according to a user input;
simulating the first vacuum system based on specifications of the chamber, the piping, and the pump; and
providing set process conditions and results of the simulation.

2. The method for designing a vacuum system of claim 1, wherein the process conditions further comprise one or more of a process pressure at a maximum gas load, a gas load at a maximum process pressure, and a gas load at a minimum process pressure.

3. The method for designing a vacuum system of claim 2, wherein providing the set process conditions and results of simulating includes comparing a conductance between respective components of entire piping of the first vacuum system with each other, extracting piping having inefficient specifications, and causing the piping to be displayed in the first vacuum system.

4. The method for designing a vacuum system of claim 3, further comprising:
copying the first vacuum system to generate a new vacuum system and causing the first vacuum system to be displayed adjacent to the new vacuum system in which the piping having inefficient specifications are displayed;
when a specification change by a user to piping among a chamber, the piping, and a pump of the new vacuum system occurs, replacing the new vacuum system with a second vacuum system to which the piping whose specification has been changed is reflected and displaying the second vacuum system;
simulating operation of the second vacuum system; and
providing results of the simulating the operation for the set process conditions.

5. The method for designing a vacuum system of claim 4, wherein the set process conditions and the results of simulating the operation are provided in one or more of graphs, tables, and text, and information on whether the results of the simulation satisfy the set process condition is included.

6. The method for designing a vacuum system of claim 5, wherein providing the results includes providing the set process conditions and the results of simulating the first vacuum system and the results of simulating the second vacuum system together so as to be compared with each other.

7. The method for designing a vacuum system of claim 3, wherein providing the set process conditions and results of simulating the first vacuum system provides guide information for changing the inefficient specifications when a particular event by a user input occurs for the piping having the inefficient specifications to be displayed in the first vacuum system.

8. The method for designing a vacuum system of claim 1, further comprising, prior to setting the process conditions of the first vacuum system:
disposing the chamber, the piping, and the pump in the virtual region according to a user input, and implementing the first vacuum system by using the disposed chamber, piping, and pump; or
invoking the first vacuum system implemented in advance and displaying the first vacuum system in the virtual region.

9-30. (canceled)

31. A method for selecting a pump of an optimal capacity when designing a vacuum system, the method for selecting a pump of an optimal capacity in a vacuum system including a chamber, piping, and a pump, comprising:
setting specifications and process conditions of a chamber, piping, and a pump of a first vacuum system disposed in a virtual region according to a user input;
simulating the first vacuum system based on the specifications of the chamber, piping, and pump;
displaying a first simulation result showing a change in chamber vacuum over time from a chamber start pressure when pumping the chamber and a second simulation result showing a change in chamber vacuum according to a change in gas load or flow, as results of the simulation; and
selecting a pump capacity that satisfies the process conditions for each of the first simulation result and the second simulation result,
wherein the process conditions comprise first process conditions related to the first simulation result and second process conditions related to the second simulation result.

32. The method for selecting a pump of an optimal capacity when designing a vacuum system of claim 31, wherein displaying the first simulation result displays the first process conditions and the second process conditions, respectively, on the first simulation result and the second simulation result.

33. The method for selecting a pump of an optimal capacity when designing a vacuum system of claim 31, wherein selecting the pump capacity includes:
if the first simulation result and the second simulation result satisfy the respective process conditions, selecting respective pump capacities that match the respective process conditions by decreasing the pump capacity, and
if any of the first simulation result and the second simulation result does not satisfy the respective process conditions, selecting pump capacities that match the respective process conditions by increasing the pump capacity.

34. The method for selecting a pump of an optimal capacity when designing a vacuum system of claim 31, wherein the first process conditions comprise a chamber start pressure, a target pressure, and a time to reach the target pressure from the chamber start pressure, and
the second process conditions comprise one or more of a process pressure at a maximum gas load or flow, a gas load at a maximum process pressure, and a gas load at a minimum process pressure.

35. The method for selecting a pump of an optimal capacity when designing a vacuum system of claim 31, wherein the first simulation result and the second simulation result are displayed using graphs.

36. The method for selecting a pump of an optimal capacity when designing a vacuum system of claim 31, further comprising:
copying the first vacuum system to generate a new vacuum system and causing the new vacuum system to be displayed adjacent to the first vacuum system;
causing a second vacuum system obtained by reflecting specifications of an alternative pump selected based on a selected pump capacity to the new vacuum system to be displayed, wherein the alternative pump has a capacity equal to or greater than the selected pump capacity;
simulating the second vacuum system; and
displaying the first simulation result and the second simulation result as a result of simulating the second vacuum system.

37. A method for displaying a design screen of a vacuum system including a chamber, piping, and a pump, comprising:
displaying a first vacuum system implemented in a virtual region on a screen according to a user input;
simulating the first vacuum system, and displaying on the screen a first simulation result and a second simulation result, which are results of the corresponding simulation;
displaying on the screen a second vacuum system implemented by reflecting piping or a pump having changed specifications in the first vacuum system according to a user input; and
simulating the second vacuum system, and displaying on the screen a third simulation result and a fourth simulation result, which are results of the corresponding simulation,
wherein specifications and process conditions of the chambers of the first vacuum system and the second vacuum system are identical, and process conditions are displayed, respectively, on the first simulation result, the second simulation result, the third simulation result, and the fourth simulation result.

38. The method for displaying a design screen of a vacuum system of claim 37, wherein simulating the second vacuum system includes accumulating and displaying the first simulation result and the third simulation result together, and accumulating and displaying the second simulation result and the fourth simulation result together.

39. The method for displaying a design screen of a vacuum system of claim 38, wherein if there exist simulation results of an n-th vacuum system where n is a positive integer greater than 2, results of at least two simulations selected by a user are accumulated and displayed together on the screen.

40. The method for displaying a design screen of a vacuum system of claim 38, wherein the first vacuum system and the second vacuum system are disposed in different regions in the screen, respectively, and respective disposed regions are adjacent to each other, and
the first simulation result and the third simulation result, and the second simulation result and the fourth simulation result are disposed in the same region in the screen.
